(19) United States
(12) Patent Application Publication
(10) Pub. No.: US 2026/0103151 A1
(43) Pub. Date: Apr. 16, 2026

(54) AIR COMPRESSOR SYSTEM AND KIT FOR MOUNTING AN AIR COMPRESSOR WITHIN A DOOR COMPARTMENT OF A VEHICLE

(71) Applicant: Integrity Auto Group, Inc., Westminster, MD (US)

(72) Inventor: Adam Andrew Fodor, Hanover, PA (US)

(73) Assignee: Integrity Auto Group, Inc., Westminster, MD (US)

(21) Appl. No.: 19/337,990

(22) Filed: Sep. 24, 2025

Related U.S. Application Data
(60) Provisional application No. 63/708,039, filed on Oct. 16, 2024.

(51) Int. Cl. B60R 11/06; B60J 5/04; B60R 11/00; B60R 16/033; B62D 43/02

(52) U.S. Cl. CPC B60R 11/06; B60J 5/0463; B60R 16/033; B62D 43/02; B60R 2011/0059

(57) ABSTRACT

An air compressor system configured to mount within a door compartment of a vehicle includes an air compressor assembly, an air tank, a fluid conduit system, an electrical communication connection, a switch, and a mounting bracket system. The air compressor assembly includes an electric motor, a compressor, an air compressor inlet, and an air compressor outlet. The air tank includes an air tank inlet and an air tank outlet. The fluid conduit system includes a first fluid conduit connecting the air compressor outlet to the air tank inlet, and a second fluid conduit connecting to and extending from the air tank outlet. The electrical communication connection is configured to connect the electric motor to a vehicle battery. The switch is operably connected between the electrical communication connection and the electric motor. The mounting bracket system includes an air compressor mounting bracket assembly configured to connect the air compressor assembly to the door compartment, and at least one air tank mounting bracket configured to connect the air tank to a spare tire carrier which is attached to a door panel of the vehicle.

### CROSS REFERENCES AND PRIORITIES

This Application claims priority from U.S. Provisional Application No. 63/708,039 filed on 16 Oct. 2024, the teachings of which are incorporated by reference herein in their entirety.

### BACKGROUND

Some vehicles, particularly vehicles used in off road applications, include factory installed or aftermarket air tanks and/or air compressors included in the vehicle. These air tanks and/or air compressors may be used for—among other things—inflating tires which have become deflated. In particular, certain off road applications may benefit from a user deflating one or more of the vehicle's tires below the recommended amount of air pressure utilized for standard road driving. When the user completes the off road activities and wishes to then drive their vehicle on city streets, highways, or the like, it benefits the user to be able to reinflate the tires to the recommended air pressure.

Several attempts have been made to integrate an air tank and/or an air compressor into a vehicle. The most common of which is to install the air tank and/or air compressor within an existing cargo storage area in the vehicle such as the bed of a truck. The air tank and/or air compressor may then be fastened to the side wall(s) and/or the floor of the storage area. In practice, these solutions are not preferred as they take up valuable cargo storage space and make storing and accessing other items—such as tools, camping gear, and the like—in the cargo storage space difficult.

One solution to this problem is disclosed in United States Patent Publication No. 2023/0365204 A1 which describes a spare tire mount that defines an internal storage space. The internal storage space provides mounting locations for a compressor and air tank assembly.

In practice, the solution disclosed in United States Patent Publication No. 2023/0365204 A1 suffers from several disadvantages. Most notably, a user must replace the vehicle's existing spare tire mount with the device disclosed therein to allow for the air tank and/or air compressor to be mounted to the vehicle. The device disclosed therein may also have different depth and height dimensions when compared to the existing spare tire mount resulting in changes to the vehicle's weight balance which can become dangerous—particularly when the vehicle is used in off road applications.

The need exists, therefore, for an improved air compressor system which can be connected to a vehicle with little to no disruption to the vehicle's cargo storage space and which causes little to no change in the vehicle's weight balance once installed.

### SUMMARY

Described herein is an air compressor system configured to mount within a door compartment of a vehicle. The air compressor system includes an air compressor assembly, an air tank, a fluid conduit system, an electrical communication connection, and a mounting bracket system. The air compressor assembly having an electric motor operably connected to a compressor, an air compressor inlet, and an air compressor outlet. The air tank having an air tank inlet and an air tank outlet. The fluid conduit system including a first fluid conduit and a second fluid conduit. The first fluid conduit connecting the air compressor outlet to the air tank inlet. The second fluid conduit connected to and extending from the air tank outlet. The electrical communication connection configured to connect the electric motor to a vehicle battery. The mounting bracket system including an air compressor mounting bracket assembly and at least one air tank mounting bracket. The air compressor mounting bracket assembly configured to connect the air compressor assembly within the door compartment. The at least one air tank mounting bracket configured to connect the air tank to a spare tire carrier which is attached to a door panel of the vehicle.

In some embodiments, the air compressor mounting bracket assembly may include a first air compressor mounting bracket. The first air compressor mounting bracket may have a first central plate, a compressor upper mounting plate extending inwardly from a first central plate upper edge, a compressor first lower mounting tab extending inwardly from a first central plate lower edge, a compressor second lower mounting tab extending inwardly from the first central plate lower edge, and a door panel first mounting plate extending outwardly from the first central plate lower edge. In such embodiments, the compressor upper mounting plate may connect to a compressor first upper mounting point and a compressor second upper mounting point by passing a first fastener through a first hole in the compressor upper mounting plate and into a first threaded hole in the compressor first upper mounting point and passing a second fastener through a second hole in the compressor upper mounting plate and into a second threaded hole in the compressor second upper mounting point. The compressor first lower mounting tab may connect to a compressor first lower mounting point by passing a third fastener through a third hole in the compressor first lower mounting tab and into a second threaded hole in the compressor first lower mounting point. The door panel first mounting plate may be configured to attach to a door compartment first mounting point by passing each of a first plurality of door compartment fasteners through a corresponding first door compartment fastener hole and into a corresponding door panel first mounting plate threaded hole.

In certain embodiments, the air tank mounting bracket may include a central tank mounting bracket flange, a tank first mounting tab, a tank second mounting tab, a spare tire first stud plate, and a spare tire second stud plate. The central tank mounting bracket flange may have a central tank mounting bracket flange outer perimeter. The tank first mounting tab may extend from a first position on the central tank mounting bracket flange outer perimeter and may include a first tank mounting stud extending from a tank first mounting tab top surface. The tank second mounting tab may extend from a second position on the central tank mounting bracket flange outer perimeter and may include a second tank mounting stud extending from a tank second mounting tab top surface. The spare tire stud plate may extend from a third position on the central tank mounting bracket flange outer perimeter and may have a spare tire first stud hole passing through a spare tire stud plate terminal end. The spare tire second stud plate may extend from a fourth position on the central tank mounting bracket flange outer perimeter with a spare tire second stud hole passing through a spare tire second stud plate terminal end. In such embodiments, the spare tire first stud hole may be configured to receive a first spare tire stud of the spare tire carrier. The spare tire second stud hole may be configured to receive a second spare tire stud of the spare tire carrier. A central tank mounting bracket flange hole may be configured to receive a third spare tire stud of the spare tire carrier. The first tank mounting stud and the second tank mounting stud may be configured to receive an air tank flange extending from an air tank outer surface. The tank second mounting tab may be located between 80° and 100° clockwise of the tank first mounting tab along the central tank mounting bracket flange outer perimeter. The spare tire first stud plate may be located between 80° and 100° clockwise of the tank second mounting tab along the central tank mounting bracket flange outer perimeter. The spare tire second stud plate may be located between 80° and 100° clockwise of the spare tire first stud plate along the central tank mounting bracket flange outer perimeter.

In some embodiments, a second fluid conduit terminal end of the second fluid conduit may be configured to connect to an air tap. The air tap may be connected to an air tap mount. The air tap mount may include a central air tap mount plate, a first air tap mount ear, and a second air tap mount ear. The central air tap mount plate may have a central air tap mount plate outer perimeter which may be substantially circular. The central air tap mount plate may include a plurality of central air tap mount plate stud holes passing therethrough, a first peripheral slot, and a second peripheral slot opposite the first peripheral slot. The first air tap mount ear may be attached to and extend from a central air tap mount plate perimeter first section between the first peripheral slot and the second peripheral slot. The first air tap mount ear may include a third peripheral slot. The second air tap mount ear may be attached to and extend from a central air tap mount plate perimeter second section opposite the central air tap mount plate perimeter first section. The second air tap mount ear may have a fourth peripheral slot. In such embodiments, the air tap mount may be configured to connect to the spare tire carrier by passing a plurality of spare tire studs through the plurality of central air tap mount plate stud holes. The air tap may be configured to selectively and slideably connect to the first peripheral slot, the second peripheral slot, the third peripheral slot, and/or the fourth peripheral slot.

In certain embodiments, the door compartment cover may include a door compartment cover main panel and a door compartment cover lip. The door compartment cover main panel may have a main panel first edge, a main panel second edge opposite the main panel first edge, a main panel first end, and a main panel second end opposite the main panel first end. The main panel first edge, main panel second edge, main panel first end, and main panel second end forming a main panel plane defining a main panel upper surface and a main panel lower surface opposite the main panel upper surface. The door compartment cover lip may be attached to and extend from the main panel first edge, and may have a lip first edge, a lip second edge opposite the lip first edge, a lip first end, and a lip second end opposite the lip first end. The lip first edge, lip second edge, lip first end, and lip second end forming a lip plane defining a lip upper surface and a lip lower surface opposite the lip upper surface. In such embodiments, at least a compartment cover first mounting hole may pass from the main panel upper surface through the main panel lower surface adjacent to a first juncture between the main panel second edge and the main panel first end or adjacent to a second juncture between the main panel second edge and the main panel second end. At least a compartment cover second mounting hole may pass from the lip upper surface through the lip lower surface adjacent to a third juncture between the lip first edge and the lip first end or adjacent to a fourth juncture between the lip first edge and the lip second end.

In some embodiments of the door compartment cover, a first bulkhead may be located within a first bulkhead aperture passing from the main panel upper surface through the main panel lower surface. In such embodiments, the first fluid conduit may include a first fluid conduit first section and a first fluid conduit second section. The first fluid conduit first section connected between the air compressor outlet and the first bulkhead and the first fluid conduit second section connected between the first bulkhead and the air tank inlet.

In certain embodiments of the door compartment cover, the door compartment cover main panel may include a plurality of door compartment cover vents. When present, each door compartment cover vent of the plurality of door compartment cover vents may pass from the main panel upper surface through the main panel lower surface.

In some embodiments, the door compartment may be located in a tailgate of a sport utility vehicle.

In certain embodiments, at least a portion of the electrical communication connection may be configured to extend through at least one rocker panel of the vehicle.

In some embodiments, the air tank may include an electrical pressure sensor in communication with the electric motor and configured to send a signal to turn off the electric motor when a predetermined amount of air pressure is detected in the air tank.

In certain embodiments, the air compressor system may include a switch operably connected within the electrical communication connection between the vehicle battery and the electric motor. In some embodiments, the switch may be located within a switch aperture passing from the main panel upper surface through the main panel lower surface.

Also disclosed herein is a kit for mounting an air compressor assembly within a door compartment of a vehicle. The kit including the air compressor assembly, an air tank, a first fluid conduit, a second fluid conduit, an electrical communication connection, a switch, an air compressor mounting bracket assembly, and at least one air tank mounting bracket. The air compressor assembly having an electric motor operably connected to a compressor, an air compressor inlet, and an air compressor outlet. The air tank having an air tank inlet and an air tank outlet. The first fluid conduit configured to connect the air compressor outlet to the air tank inlet. The second fluid conduit configured to connect to and extend from the air tank outlet. The electrical communication connection configured to connect the electric motor to a vehicle battery. The switch configured to operably connect within the electrical communication connection between the vehicle battery and the electric motor. The air compressor mounting bracket assembly configured to connect the air compressor assembly within the door compartment. The at least one air tank mounting bracket configured to connect the air tank to a spare tire carrier which is attached to a door panel of the vehicle.

In some embodiments of the kit, the air compressor mounting bracket assembly may include a first air compressor mounting bracket. The first air compressor mounting bracket may have a first central plate, a compressor upper mounting plate extending inwardly from a first central plate upper edge, a compressor first lower mounting tab extending inwardly from a first central plate lower edge, a compressor second lower mounting tab extending inwardly from the first central plate lower edge, and a door panel first mounting plate extending outwardly from the first central plate lower edge. In such embodiments, the compressor upper mounting plate may connect to a compressor first upper mounting point and a compressor second upper mounting point by passing a first fastener through a first hole in the compressor upper mounting plate and into a first threaded hole in the compressor first upper mounting point and passing a second fastener through a second hole in the compressor upper mounting plate and into a second threaded hole in the compressor second upper mounting point. The compressor first lower mounting tab may connect to a compressor first lower mounting point by passing a third fastener through a third hole in the compressor first lower mounting tab and into a second threaded hole in the compressor first lower mounting point. The door panel first mounting plate may be configured to attach to a door compartment first mounting point by passing each of a first plurality of door compartment fasteners through a corresponding first door compartment fastener hole and into a corresponding door panel first mounting plate threaded hole.

In certain embodiments of the kit, the air tank mounting bracket may include a central tank mounting bracket flange, a tank first mounting tab, a tank second mounting tab, a spare tire first stud plate, and a spare tire second stud plate. The central tank mounting bracket flange may have a central tank mounting bracket flange outer perimeter. The tank first mounting tab may extend from a first position on the central tank mounting bracket flange outer perimeter and may include a first tank mounting stud extending from a tank first mounting tab top surface. The tank second mounting tab may extend from a second position on the central tank mounting bracket flange outer perimeter and may include a second tank mounting stud extending from a tank second mounting tab top surface. The spare tire stud plate may extend from a third position on the central tank mounting bracket flange outer perimeter and may have a spare tire first stud hole passing through a spare tire stud plate terminal end. The spare tire second stud plate may extend from a fourth position on the central tank mounting bracket flange outer perimeter with a spare tire second stud hole passing through a spare tire second stud plate terminal end. In such embodiments, the spare tire first stud hole may be configured to receive a first spare tire stud of the spare tire carrier. The spare tire second stud hole may be configured to receive a second spare tire stud of the spare tire carrier. A central tank mounting bracket flange hole may be configured to receive a third spare tire stud of the spare tire carrier. The first tank mounting stud and the second tank mounting stud may be configured to receive an air tank flange extending from an air tank outer surface. The tank second mounting tab may be located between 80° and 100° clockwise of the tank first mounting tab along the central tank mounting bracket flange outer perimeter. The spare tire first stud plate may be located between 80° and 100° clockwise of the tank second mounting tab along the central tank mounting bracket flange outer perimeter. The spare tire second stud plate may be located between 80° and 100° clockwise of the spare tire first stud plate along the central tank mounting bracket flange outer perimeter.

In some embodiments, the kit may include an air tap and an air tap mount. The air tap mount may include a central air tap mount plate, a first air tap mount ear, and a second air tap mount ear. The central air tap mount plate may have a central air tap mount plate outer perimeter which may be substantially circular. The central air tap mount plate may include a plurality of central air tap mount plate stud holes passing therethrough, a first peripheral slot, and a second peripheral slot opposite the first peripheral slot. The first air tap mount ear may be attached to and extend from a central air tap mount plate perimeter first section between the first peripheral slot and the second peripheral slot. The first air tap mount ear may include a third peripheral slot. The second air tap mount ear may be attached to and extend from a central air tap mount plate perimeter second section opposite the central air tap mount plate perimeter first section. The second air tap mount ear may have a fourth peripheral slot. In such embodiments, the air tap mount may be configured to connect to the spare tire carrier by passing a plurality of spare tire studs through the plurality of central air tap mount plate stud holes. The air tap may be configured to selectively and slideably connect to the first peripheral slot, the second peripheral slot, the third peripheral slot, and/or the fourth peripheral slot.

In certain embodiments, the kit may include a door compartment cover which may include a door compartment cover main panel and a door compartment cover lip. The door compartment cover main panel may have a main panel first edge, a main panel second edge opposite the main panel first edge, a main panel first end, and a main panel second end opposite the main panel first end. The main panel first edge, main panel second edge, main panel first end, and main panel second end forming a main panel plane defining a main panel upper surface and a main panel lower surface opposite the main panel upper surface. The door compartment cover lip may be attached to and extend from the main panel first edge, and may have a lip first edge, a lip second edge opposite the lip first edge, a lip first end, and a lip second end opposite the lip first end. The lip first edge, lip second edge, lip first end, and lip second end forming a lip plane defining a lip upper surface and a lip lower surface opposite the lip upper surface. In such embodiments, at least a compartment cover first mounting hole may pass from the main panel upper surface through the main panel lower surface adjacent to a first juncture between the main panel second edge and the main panel first end or adjacent to a second juncture between the main panel second edge and the main panel second end. At least a compartment cover second mounting hole may pass from the lip upper surface through the lip lower surface adjacent to a third juncture between the lip first edge and the lip first end or adjacent to a fourth juncture between the lip first edge and the lip second end.

In some embodiments of the door compartment cover, a first bulkhead may be located within a first bulkhead aperture passing from the main panel upper surface through the main panel lower surface. In such embodiments, the first fluid conduit may include a first fluid conduit first section and a first fluid conduit second section. The first fluid conduit first section connected between the air compressor outlet and the first bulkhead and the first fluid conduit second section connected between the first bulkhead and the air tank inlet.

In certain embodiments of the door compartment cover, the door compartment cover main panel may include a plurality of door compartment cover vents. When present, each door compartment cover vent of the plurality of door compartment cover vents may pass from the main panel upper surface through the main panel lower surface.

In certain embodiments of the kit, at least a portion of the electrical communication connection may be configured to extend through at least one rocker panel of the vehicle.

In certain embodiments of the kit, the air compressor system may include a switch operably connected within the electrical communication connection between the vehicle battery and the electric motor. In some embodiments, the switch may be located within a switch aperture passing from the main panel upper surface through the main panel lower surface.

### BRIEF DESCRIPTION OF FIGURES

FIG. 1 is an orthographic view of an exemplary embodiment of an air compressor system configured to mount within a door compartment of a vehicle.

FIG. 2 is a partially exploded view of the exemplary embodiment of an air compressor system of FIG. 1.

FIG. 3 is a partially exploded view of an exemplary embodiment of an air compressor assembly and air compressor mounting brackets.

FIG. 4 is an assembled view of the exemplary embodiment of an air compressor assembly and air compressor mounting brackets of FIG. 3.

FIG. 5 is a partially exploded view of an exemplary embodiment of an air compressor assembly and air compressor mounting brackets for installation within a door compartment of a vehicle.

FIG. 6 is an assembled view of an exemplary embodiment of an air compressor assembly and air compressor mounting brackets installed within a door compartment of a vehicle.

FIG. 7 is a partially exploded view of an exemplary embodiment of an air tank, cover, and air tank mounting brackets.

FIG. 8 is an assembled view of the exemplary embodiment of an air tank, cover, and air tank mounting brackets of FIG. 7.

FIG. 9 is a partially exploded view of an exemplary embodiment of an air tank and air tank mounting brackets for installation within a spare tire carrier of a vehicle.

FIG. 10 is an assembled view of an exemplary embodiment of an air tank and air tank mounting brackets installed within a spare tire carrier of a vehicle.

FIG. 11 is a cross section view of an exemplary embodiment of an air compressor system mounted within a door compartment of a vehicle.

FIG. 12A is a rear view of a bulkhead for an air compressor system connected to a portion of a spare tire carrier of a vehicle with the bulkhead in a first position.

FIG. 12B is a rear view of a bulkhead for an air compressor system connected to a portion of a spare tire carrier of a vehicle with the bulkhead in a second position.

### DETAILED DESCRIPTION

Disclosed herein is an air compressor system configured to mount within a door compartment of a vehicle and a kit for mounting an air compressor assembly within a door compartment of a vehicle. The air compressor system and the kit are described below with reference to the Figures. As described herein, the following numbers refer to the following structures as noted in the Figures.
10 refers to an air compressor system.
50 refers to a vehicle.
51 refers to a door panel.
52 refers to a vehicle battery.
53 refers to a spare tire carrier.
55 refers to a door compartment.
56 refers to a door compartment first mounting point.
57 refers to a door compartment second mounting point.
58 refers to a door compartment third mounting point.
100 refers to an air compressor assembly.
110 refers to an electric motor.
120 refers to a compressor.
140 refers to an air compressor outlet.
151 refers to a compressor first lower mounting point.
152 refers to a compressor first upper mounting point.
153 refers to a compressor second upper mounting point.
200 refers to an air tank.
210 refers to an air tank inlet.
220 refers to an air tank outlet.
230 refers to an air tank flange.
300 refers to a fluid conduit system.
310 refers to a first fluid conduit.
311 refers to a first bulkhead.
312 refers to a first bulkhead aperture.
313 refers to a first fluid conduit first section.
314 refers to a first fluid conduit second section.
320 refers to a second fluid conduit.
321 refers to a second fluid conduit terminal end.
322 refers to an air tap.
330 refers to an air tap mount.
340 refers to a central air tap mount plate.
341 refers to a central air tap mount plate stud hole.
342 refers to a first peripheral slot.
343 refers to a second peripheral slot.
350 refers to a first air tap mount ear.
351 refers to a central air tap mount plate perimeter first section.
352 refers to a third peripheral slot.
360 refers to a second air tap mount ear.
361 refers to a central air tap mount plate perimeter second section.
362 refers to a fourth peripheral slot.
400 refers to an electrical communication connection.
410 refers to a switch.
411 refers to a switch aperture.
500 refers to a mounting bracket system.
510 refers to an air compressor mounting bracket assembly.
520 refers to an air tank mounting bracket.
521 refers to a central tank mounting bracket flange.
522 refers to a tank first mounting tab.
523 refers to a spare tire third stud hole.
524 refers to a tank second mounting tab.
526 refers to a spare tire first stud plate.
527 refers to a spare tire first stud hole.
528 refers to a spare tire second stud plate.
529 refers to a spare tire second stud hole.
530 refers to a first air compressor mounting bracket.
531 refers to a first central plate.
532 refers to a compressor upper mounting plate.
533 refers to a compressor first lower mounting tab.
534 refers to a compressor second lower mounting tab.
535 refers to a door panel first mounting plate.
600 refers to a door compartment cover.
610 refers to a door compartment cover main panel.
611 refers to a main panel first edge.
612 refers to a main panel second edge.
613 refers to a main panel first end.
614 refers to a main panel second end.
615 refers to a main panel upper surface.
616 refers to a main panel lower surface.
617 refers to a compartment cover first mounting hole.
618 refers to a door compartment cover vent.
620 refers to a door compartment cover lip.
621 refers to a lip first edge.
622 refers to a lip second edge.
623 refers to a lip first end.
624 refers to a lip second end.
625 refers to a lip upper surface.
626 refers to a lip lower surface.
627 refers to a compartment cover second mounting hole.

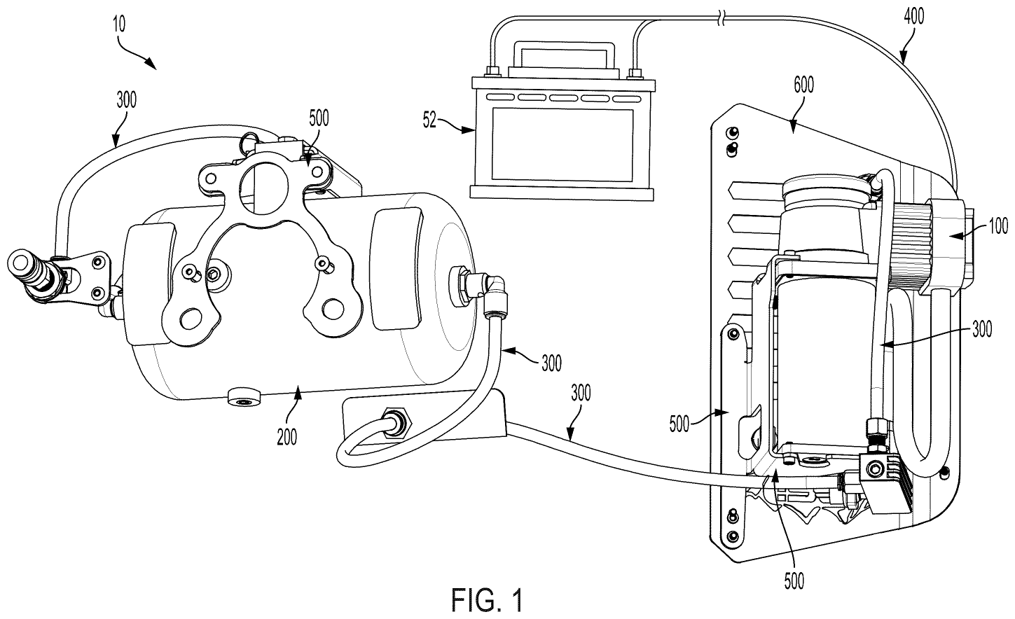

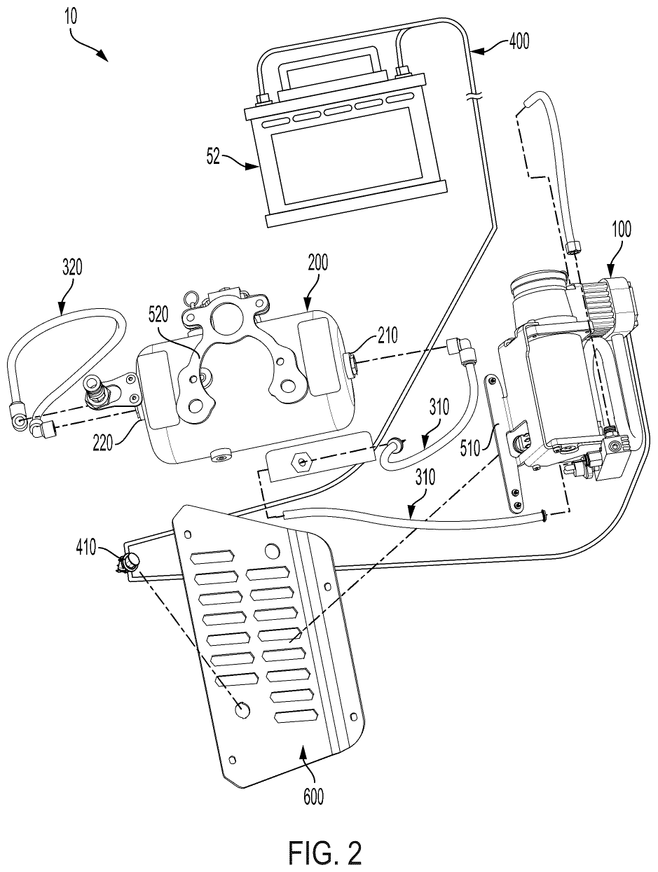

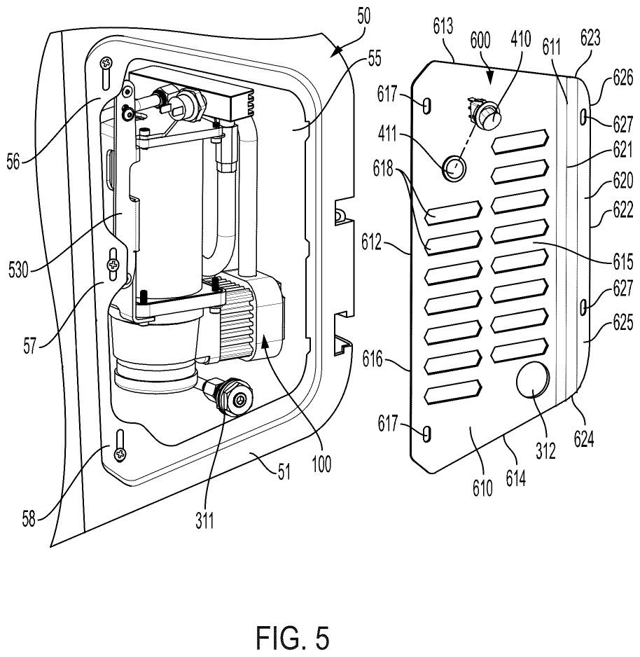

FIG. 1 illustrates a perspective view of an exemplary embodiment of an air compressor system (10) configured to mount within a door compartment ((55) as shown in FIG. 5) of a vehicle with FIG. 2 illustrating a partially exploded view thereof. As shown in FIG. 1 and FIG. 2, the air compressor system may comprise an air compressor assembly (100), an air tank (200), a fluid conduit system (300), an electrical communication connection (400), and a mounting bracket system (500). Certain embodiments may also include a door compartment cover (600) as illustrated in FIG. 1 and FIG. 2—exemplary embodiments of which are described herein. However, the door compartment cover is not considered a required feature and is thus considered optional.

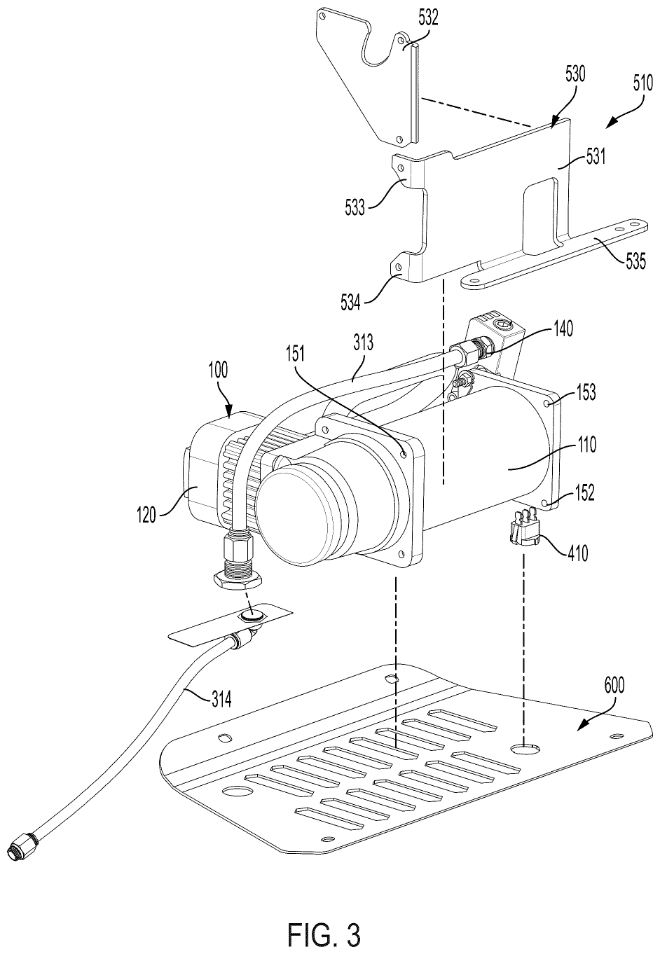

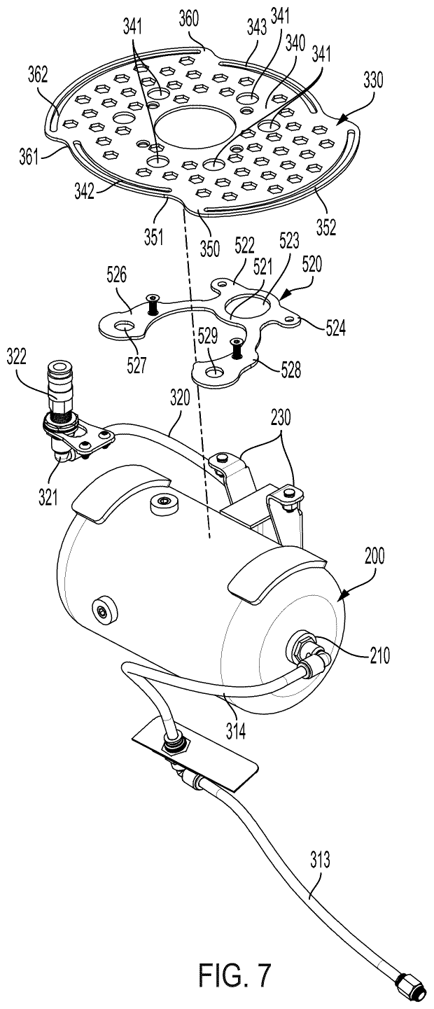

The fluid conduit system (300) may include at least a first fluid conduit (310) and a second fluid conduit (320). The first fluid conduit configured to connect an air compressor outlet ((140) as shown in FIG. 3) to an air tank inlet ((210) as shown in FIG. 7). The second fluid conduit configured to connect to and extend from an air tank outlet ((220) as shown in FIG. 7). The fluid conduits may take many forms such as a flexible hose, a rigid tube, or the like. In some embodiments, one or more ends of the fluid conduits may include a fitting configured to thread onto/into or clip onto/into a corresponding fitting on the respective air compressor inlet, air compressor outlet, air tank inlet, and/or air tank outlet.

The electrical communication connection (400) may include a plurality of wires which may be in the form of a wiring harness. At least one of the wires may connect to a battery which may be the vehicle battery (52) and may be located within the vehicle's engine bay—or which may be a secondary battery provided specifically for providing a source of electrical energy for various components of the air compressor system (10), most specifically for the electric motor ((110) as shown in FIG. 3) of the air compressor assembly (100). Within the electrical communication connection between the battery and the electric motor will be at least one switch (410) which is operable to close a circuit between the battery and the electric motor—thus providing electrical energy to power the electric motor—when the switch is in an on position, and may open the circuit—thus eliminating the source of electrical energy for powering the electric motor—when the switch is in an off position.

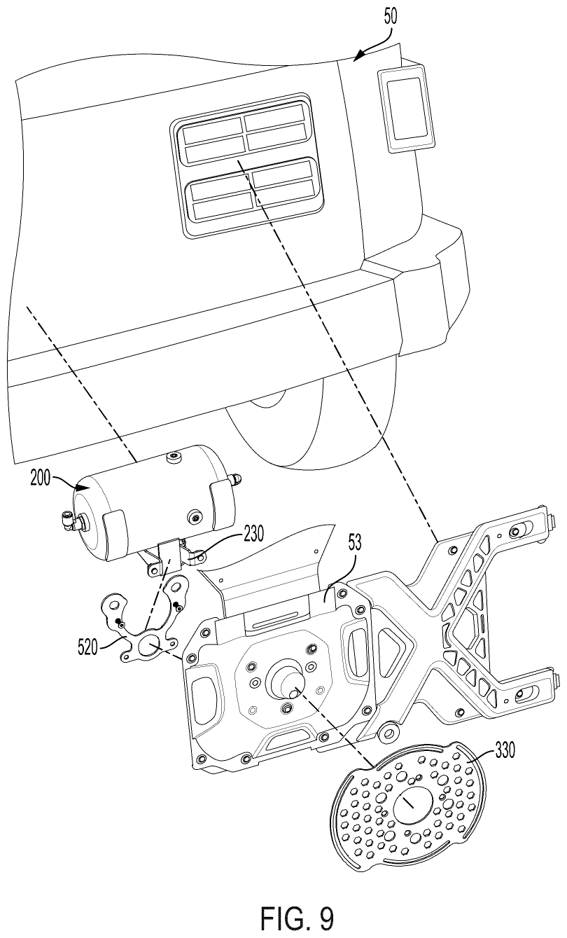

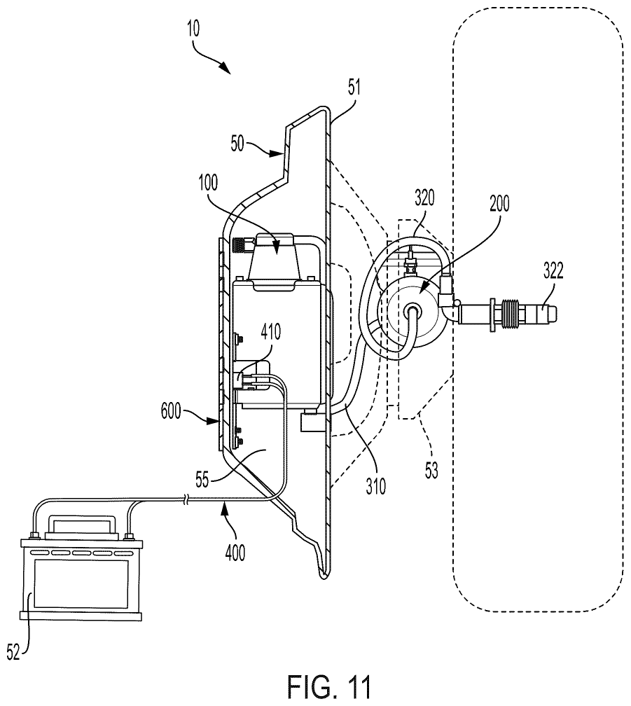

The mounting bracket system (500) may take many forms, an exemplary embodiment of which is illustrated in the Figures. In general, the mounting bracket system should include at least one air compressor mounting bracket assembly (510) and at least one air tank mounting bracket (520). The air compressor mounting bracket assembly being configured to connect the air compressor assembly (100) to the vehicle ((50) as shown in FIG. 5) within the door compartment ((55) as shown in FIG. 5). The air tank mounting bracket being configured to connect the air tank (200) to a spare tire carrier ((53) as shown in FIG. 9) which is attached to a door panel ((51) as shown in FIG. 11) of the vehicle.

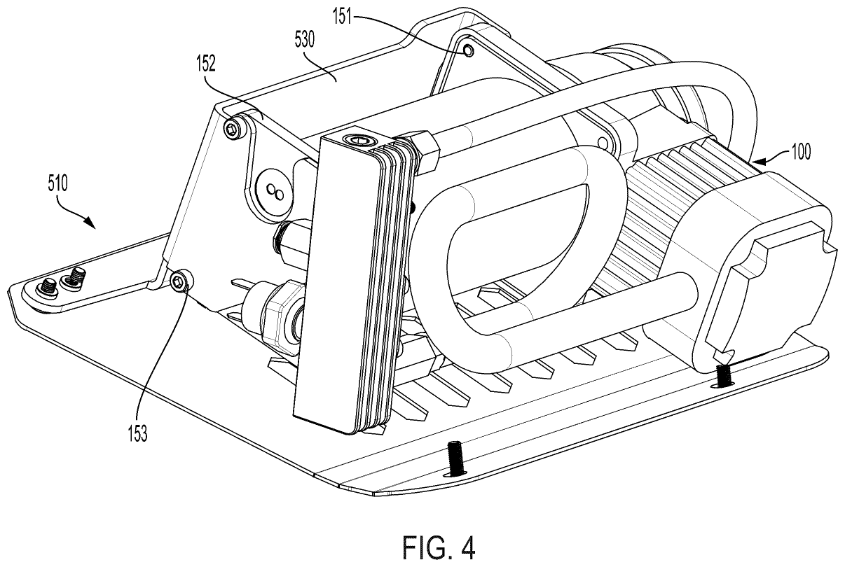

FIG. 3 illustrates a partially exploded view of an exemplary embodiment of an air compressor assembly (100) with at least one air compressor mounting bracket assembly (510) while FIG. 4 illustrates an assembled view thereof. As shown in FIGS. 3 and 4, the air compressor assembly includes an electric motor (110) operably connected to a compressor (120). The compressor may come in many forms. One such form is a reciprocating compressor or piston compressor in which one or more pistons driven by a crankshaft operably connected to the electric motor compresses air within the compressor for discharging at high pressures. Another form is a rotary screw compressor in which two closely meshing spiral rotors operably connected to the electric motor compress air within the compressor for discharging at high pressure. The air to be compressed enters the compressor through an air compressor inlet (not shown) which is fluidly connected to the compressor and the compressed air exits the compressor through an air compressor outlet (140) which is also fluidly connected to the compressor.

As shown in FIG. 3 and FIG. 4, the at least one air compressor mounting bracket assembly (510) may include a first air compressor mounting bracket (530). In exemplary embodiments, the first air compressor mounting bracket may include a first central plate (531). Extending inwardly from a first central plate upper edge may be a compressor upper mounting plate (532) which may be permanently or removably connected to the first central plate upper edge. Extending inwardly from opposing ends of a first central plate lower edge may be a compressor first lower mounting tab (533) and a compressor second lower mounting tab (534). Extending outwardly from the first central plate lower edge may be a door panel first mounting plate (535).

The compressor upper mounting plate (532) may be configured to connect to a compressor first upper mounting point (152) by passing a first fastener through a first hole in the compressor upper mounting plate and into a first threaded hole in the compressor first upper mounting point. The compressor upper mounting plate may also be configured to connect to a compressor second upper mounting point (153) by passing a second fastener through a second hole in the compressor upper mounting plate and into a second threaded hole in the compressor second upper mounting point. The compressor first lower mounting tab (533) may be configured to connect to a compressor first lower mounting point (151) by passing a third fastener through a third hole in the compressor first lower mounting tab and into a third threaded hole in the compressor first lower mounting point. Preferably, the first fastener, the second fastener, and the third fastener will each independently be a bolt, a screw, or the like.

The door panel first mounting plate (535) may be configured to connect to a door compartment first mounting point ((56) as shown in FIG. 5) by passing each of a first plurality of door compartment fasteners through a corresponding first door compartment fastener hole and into a corresponding door panel first mounting plate threaded hole. Preferably, each door compartment fastener of the plurality of door compartment fasteners will be a bolt, a screw, or the like.

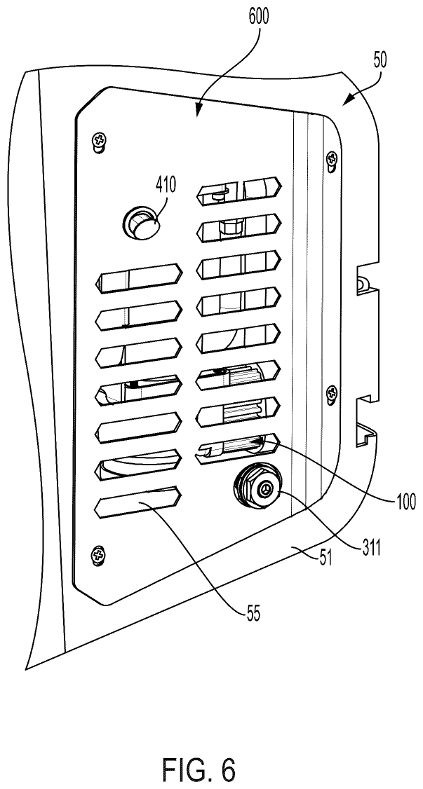

FIGS. 5 and 6 illustrate exemplary embodiments of attaching the air compressor assembly (100) within the door compartment (55) of the vehicle (50). As shown in FIGS. 5 and 6, the air compressor assembly is first assembled including with the air compressor mounting bracket assembly (510) which may include the first air compressor mounting bracket (530) illustrated in FIGS. 3 and 4 and described herein. The assembled air compressor assembly is then inserted into a void of the door compartment via an aperture before connecting the air compressor assembly to the corresponding door compartment first mounting point (56) using the air compressor mounting bracket assembly, door compartment second mounting point (57), and door compartment third mounting point (58) as described herein.

In certain embodiments, the air compressor system (10) may further include a door compartment cover (600) as illustrated in FIGS. 5 and 6. When present, the door compartment cover may include a door compartment cover main panel (610) and a door compartment cover lip (620). The door compartment cover main panel including a main panel first edge (611), a main panel second edge (612) opposite the main panel first edge, a main panel first end (613), and a main panel second end (614) opposite the main panel first end. The main panel first edge, main panel second edge, main panel first end, and main panel second end form a main panel plane which defines a main panel upper surface (615) with a main panel lower surface (616) opposite the main panel upper surface.

As shown in FIG. 5, the door compartment cover lip (620) may be attached to and extend from the main panel first edge (611). The door compartment cover lip preferably includes a lip first edge (621), a lip second edge (622) opposite the lip first edge, a lip first end (623), and a lip second end (624) opposite the lip first end. The lip first edge, lip second edge, lip fist end, and lip second end form a lip plane which defines a lip upper surface (625) with a lip lower surface (626) opposite the lip upper surface.

The door compartment cover (600) may include a plurality of compartment cover mounting holes configured to connect the door compartment cover to the door compartment by a plurality of fasteners such as bolts, screws, rivets, or the like. In the exemplary embodiment shown in FIGS. 5 and 6, the door compartment cover includes at least a compartment cover first mounting hole (617) which passes from the main panel upper surface (615) through the main panel lower surface (616) adjacent to a first juncture between the main panel second edge (612) and the main panel first end (613). Alternatively, or additionally, the compartment cover first mounting hole may be located adjacent to a second juncture between the main panel second edge and the main panel second end (614). Also, in the exemplary embodiment shown in FIGS. 5 and 6, the door compartment cover includes at least a compartment cover second mounting hole (627) which passes from the lip upper surface (625) through the lip lower surface (626) adjacent to a third juncture between the lip first edge (621) and the lip first end (623). Alternatively, or additionally, the compartment cover second mounting hole may be located adjacent to a fourth juncture between the lip first edge and the lip second end (624).

In certain embodiments, such as those shown in FIGS. 5 and 6, there may be a switch (410) which may be located within a switch aperture (411). The switch aperture passing from the main panel upper surface (615) through the main panel lower surface (616). In doing so, the switch may be accessible to a user on the interior surface of the vehicle's door, which may be a tailgate of a sport utility vehicle.

Similarly, in some embodiments, such as those shown in FIGS. 5 and 6, a first bulkhead (311) may be located within a first bulkhead aperture (312). The first bulkhead aperture passing from the main panel upper surface (615) through the main panel lower surface (616). When the first bulkhead is present, the first fluid conduit (310) may include a first fluid conduit first section (313) and a first fluid conduit second section (314). The first fluid conduit first section may be connected between the air compressor outlet ((140) as shown in FIG. 3) and the first bulkhead while the first fluid conduit second section may be connected between the first bulkhead and the air tank inlet ((210) as shown in FIG. 7).

In some embodiments, the door compartment cover main panel (610) and/or the door compartment cover lip (620) may include a plurality of door compartment cover vents (618) permitting atmospheric air to enter the door compartment as illustrated in FIGS. 5 and 6. When present in the door compartment cover main panel, the plurality of door compartment cover vents may pass from the main panel upper surface (615) through the main panel lower surface (616). When present in the door compartment cover lip, the plurality of door compartment cover vents may pass from the lip upper surface (625) through the lip lower surface (626).

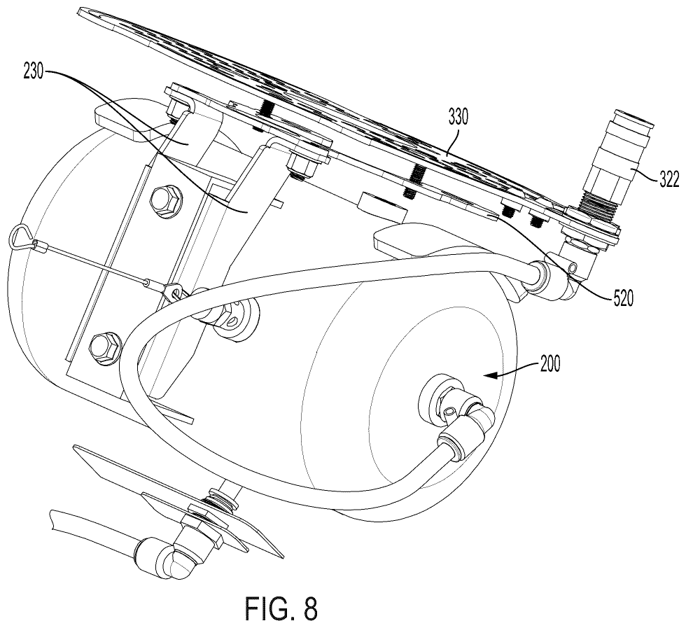

FIG. 7 illustrates a partially exploded view of an exemplary embodiment of an air tank (200) with at least one air tank mounting bracket (520) while FIG. 8 illustrates an assembled view thereof. As shown in FIGS. 7 and 8, the air tank includes an air tank inlet (210) configured to connect to the first fluid conduit (310) to receive compressed air passing from the compressor ((120) as shown in FIG. 3) out of the air compressor outlet ((140) as shown in FIG. 3) and through the first fluid conduit. The air tank also includes an air tank outlet ((220) as shown in FIG. 2) configured to connect to the second fluid conduit (320).

As shown in FIGS. 7 and 8, the air tank mounting bracket includes a central tank mounting bracket flange (521) having a central tank mounting bracket flange outer perimeter with a spare tire third stud hole (523). Connected to and extending from a first position on the central tank mounting bracket flange outer perimeter is a tank first mounting tab (522). In some embodiments, a first tank mounting stud (not shown) may extend from a tank first mounting tab top surface. Similarly, connected to extending from a second position on the central tank mounting bracket flange outer perimeter is a tank second mounting tab (524). In certain embodiments, a second tank mounting stud (not shown) may extend from a tank second mounting tab top surface. Connected to and extending from a third position on the central tank mounting bracket flange outer perimeter is a spare tire first stud plate (526). The spare tire first stud plate having a spare tire first stud hole (527) passing through a spare tire first stud plate terminal end. Similarly, connected to and extending from a fourth position on the central tank mounting bracket flange outer perimeter is a spare tire second stud plate (528). The spare tire second stud plate having a spare tire second stud hole (529) passing through a spare tire second stud plate terminal end.

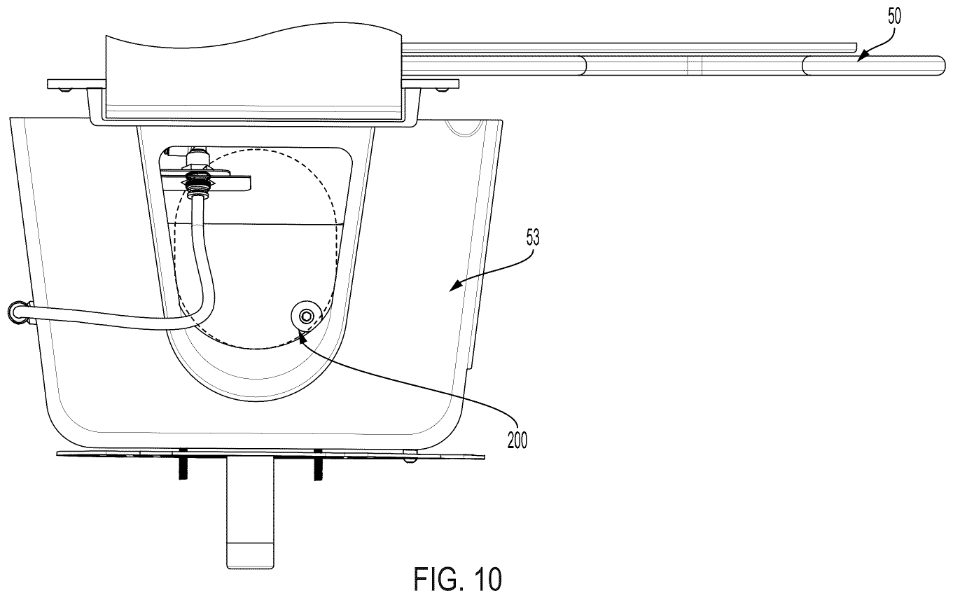

To connect the air tank (200) to the spare tire carrier ((53) as shown in FIGS. 9 and 10), the spare tire first stud hole (527) is configured to receive a first spare tire stud of the spare tire carrier while the spare tire second stud hole (529) is configured to receive a second spare tire stud of the spare tire carrier as illustrated in FIGS. 7 and 8. Similarly, a central tank mounting bracket flange hole is configured to receive a third spare tire stud of the spare tire carrier. An air tank flange (230) extending from the air tank outer surface is configured to mate with the first tank mounting stud and the second tank mounting stud. Mating the air tank flange to the first tank mounting stud and the second tank mounting stud may involve passing fasteners through holes in the air tank flange and threading them into a threaded hole in each of the first tank mounting stud and/or the second tank mounting stud.

Preferably, the tank second mounting tab (524) will be located between 80° and 100° clockwise of the tank first mounting tab (522) along the central tank mounting bracket flange outer perimeter. Further preferably, the spare tire first stud plate (526) will be located between 80° and 100° clockwise of the tank second mounting tab along the central tank mounting bracket flange outer perimeter. Also preferably, the spare tire second stud plate (528) will be located between 80° and 100° clockwise of the spare tire first stud plate along the central tank mounting bracket flange outer perimeter.

Also shown in FIGS. 7 and 8 is an air tap mount (330) having an air tap (322). As shown in FIGS. 7 and 8, the air tap mount includes a central air tap mount plate (340) having a central air tap mount plate outer perimeter which is substantially circular. The air tap mount plate includes a plurality of central air tap mount plate stud holes (341) passing therethrough. The central air tap mount plate also includes a first peripheral slot (342) and a second peripheral slot (343) opposite the first peripheral slot. Attached to and extending from a central air tap mount plate perimeter first section (351) between the first peripheral slot and the second peripheral slot is a first air tap mount ear (350). The first air tap mount ear including a third peripheral slot (352). Similarly, attached to and extending from a central air tap mount plate perimeter second section (361) opposite the central air tap mount plate perimeter first section is a second air tap mount ear (360). The second air tap mount ear including a fourth peripheral slot (362).

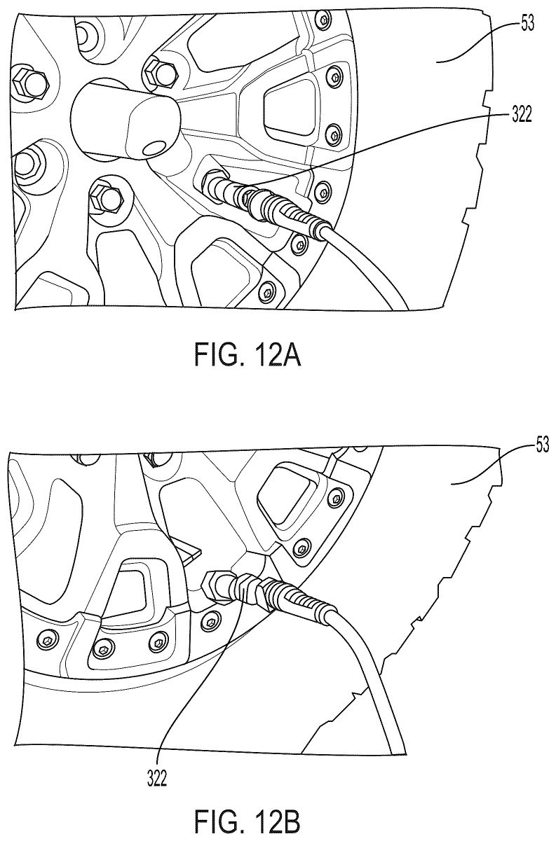

The air tap mount (330) may be configured to connect to the spare tire carrier ((53) as shown in FIGS. 9 and 10) with a plurality of spare tire studs configured to pass through the plurality of central air tap mount plate stud holes (341). The air tap (322) is then configured to selectively and slideably connect to the first peripheral slot, the second peripheral slot, the third peripheral slot, and/or the fourth peripheral slot allowing the position of the air tap to be altered such that the air tap may pass through any number of different spokes in the spare tire when the spare tire is mounted to the spare tire carrier as illustrated in FIGS. 12A and 12B. The air tap through the spare tire provides external usage, while the air tap on the inside of the cover provides an alternate hookup. The air tap itself is adjustable for multiple wheel sizes.

FIGS. 9 and 10 illustrate exemplary embodiments of attaching the air tank (200) to the spare tire carrier (53) of the vehicle (50). As shown in FIGS. 9 and 10, the air tank is first assembled including with the air tank mounting bracket(s) (520) as illustrated in FIGS. 7 and 8 and described herein. The assembled air tank is then connected to the studs extending from the spare tire carrier as described herein.

FIG. 11 illustrates a cross section of an exemplary embodiment of an air compressor system (10) installed in a vehicle (50). As illustrated in FIG. 11, the air compressor assembly (100), the air compressor mounting bracket assembly (510) connect the air compressor assembly within the door compartment (55) while the air tank mounting bracket(s) (520) connect the air tank (200) to the spare tire carrier (53) which is attached to a door panel (51) of the vehicle. As shown in FIG. 11, the door panel may form an exterior wall of the door compartment.

FIG. 11 further illustrates portions of the electrical communication connection (400) which extend through one or more rocker panels of the vehicle. A rocker panel is a well-known feature of many vehicles and refers to the body section of the vehicle below the base of the door openings. A rocker panel often include longitudinal voids which may be covered by one or more removable panels which allow access to said longitudinal voids. To connect the electrical communication connection to the vehicle battery (52), portions of the electrical communication connection may be extended into and through the longitudinal void in one or more rocker panel including rocker panels corresponding to the vehicle's front drivers side door, the vehicle's rear drivers side door, the vehicle's front passenger side door, and/or the vehicle's rear passenger side door.

In certain embodiments, the air tank (200) may include an electrical pressure sensor in communication with the electric motor and configured to send a signal to turn off the electric motor when a predetermined amount of air pressure is detected in the air tank. The signal sent to turn off the electric motor may include to turn off the switch (410) thereby opening the circuit between the vehicle's battery and the electric motor when the predetermined amount of air pressure is detected in the air tank.

The air compressor system may also be provided in the form of a kit for connecting an air compressor assembly (100) to a door compartment (55) of a vehicle (50). The kit will preferably be provided with an air compressor assembly of any type described herein and illustrated in the Figures, an air tank (200) of any type described herein and illustrated in the Figures, a first fluid conduit (310) of any type described herein and illustrated in the Figures, a second fluid conduit (320) of any type described herein and illustrated in the Figures, an electrical communication connection (400) of any type described herein and illustrated in the Figures, a switch of any type described herein and illustrated in the Figures, air compressor mounting bracket assembly (510) of any type described herein and illustrated in the figures, and at least one air tank mounting bracket (520) of any type described herein and illustrated in the Figures. Optionally, the kit may include an air tank flange (230) of any type described herein and illustrated in the Figures, a first bulkhead (311) of any type described herein and illustrated in the Figures, an air tap (322) of any type described herein and illustrated in the Figures, an air tap mount (330) of any type described herein and illustrated in the Figures, and/or a door compartment cover (600) of any type described herein and illustrated in the Figures.

Various components of the air compressor system and the kit disclosed herein—including, but not limited to, the air tank, the air tap mount, the mounting bracket system, and the door compartment cover—may be manufactured using any number of different materials and any number of different manufacturing techniques. Preferably, the various components such as the air tank, the air tap mount, the mounting bracket system, and the door compartment cover will be manufactured of a metal material such as steel, stainless steel, aluminum or the like. However, embodiments may exist in which one or more of these components is manufactured of a rigid plastic material such as acrylonitrile butadiene styrene (ABS), polyethylene (PE), nylon, and the like. Manufacturing techniques may include cutting, bending, grinding, welding, casting, forging, injection molding and the like using common equipment for conducting such operations. Components such as the air compressor assembly, the fluid conduit system, the first bulkhead, the air tap, the electrical communication connection, and the switch may be manufactured using common manufacturing techniques for such components or may be purchased in a premanufactured and preassembled form to which various other components of the system and/or the kit may be added.

The various embodiments of an air compressor system and kit described herein represent an improvement over prior attempts to integrate an air tank and/or an air compressor assembly into a vehicle. By connecting the air compressor assembly within a door compartment in the vehicle with the air tank connected to the vehicle's existing spare tire carrier, the system uses very little to no space within the vehicle's cargo storage area which remains available for storing tools, camping equipment, and the like. Additionally, by utilizing the vehicle's existing spare tire carrier instead of installing an entirely new spare tire carrier, the system causes very little to no change in the vehicle's weight balance. Placement of the air compressor system into a hidden compartment of the vehicle utilizes unused space and makes the installed product have the appearance of an OEM features as if it came pre-installed from the car manufacturer. The concealed air tank provides additional capacity.

While the air compressor system has been described as having one or more exemplary designs, the present article and method may be further modified within the spirit and scope of this disclosure. This application is therefore intended to cover any variations, uses, or adaptations of the air compressor system using its general principles.

What is claimed is:

1. An air compressor system (10) configured to mount within a door compartment (55) of a vehicle (50), said air compressor system comprising:
an air compressor assembly (100) having an electric motor (110) operably connected to a compressor (120), an air compressor inlet, and an air compressor outlet (140);
an air tank (200) having an air tank inlet (210) and an air tank outlet (220);
a fluid conduit system (300) comprising:
a first fluid conduit (310) connecting the air compressor outlet to the air tank inlet, and
a second fluid conduit (320) connected to and extending from the air tank outlet;
an electrical communication connection (400) configured to connect the electric motor to a vehicle battery (52); and
a mounting bracket system (500) comprising:
an air compressor mounting bracket assembly (510) configured to connect the air compressor assembly within the door compartment; and
at least one air tank mounting bracket (520) configured to connect the air tank to a spare tire carrier (53) which is attached to a door panel (51) of the vehicle.

2. The air compressor system of claim 1, wherein the air compressor mounting bracket assembly comprises a first air compressor mounting bracket (530) having a first central plate (531), a first upper compressor mounting plate (532) extending inwardly from a first central plate upper edge, a compressor first lower mounting tab (533) extending inwardly from a first central plate lower edge, a compressor second lower mounting tab (534) extending inwardly from the first central plate lower edge, and a door panel first mounting plate (535) extending outwardly from the first central plate lower edge; and wherein the compressor upper mounting plate connects to a compressor first upper mounting point (152) and a compressor second upper mounting point (153) by passing a first fastener through a first hole in the compressor upper mounting plate and into a first threaded hole in the compressor first upper mounting point and passing a second fastener through a second hole in the compressor upper mounting plate and into a second threaded hole in the compressor second upper mounting point, the compressor first lower mounting tab connects to a compressor first lower mounting point (151) by passing a third fastener through a third hole in the compressor first lower mounting tab and into a second threaded hole in the compressor first lower mounting point, and the door panel first mounting plate is configured to attach to a door compartment first mounting point (56) by passing each of a first plurality of door compartment fasteners through a corresponding first door compartment fastener hole and into a corresponding door panel first mounting plate threaded hole.

3. The air compressor system of claim 1, wherein the air tank mounting bracket comprises
a central tank mounting bracket flange (521) having an central tank mounting bracket flange outer perimeter;
a tank first mounting tab (522) extending from a first position on the central tank mounting bracket flange outer perimeter with a first tank mounting stud extending from a tank first mounting tab top surface;
a tank second mounting tab (524) extending from a second position on the central tank mounting bracket flange outer perimeter with a second tank mounting stud extending from a tank second mounting tab top surface;
a spare tire first stud plate (526) extending from a third position on the central tank mounting bracket flange outer perimeter with a spare tire first stud hole (527) passing through a spare tire first stud plate terminal end; and
a spare tire second stud plate (528) extending from a fourth position on the central tank mounting bracket flange outer perimeter with a spare tire second stud hole (529) passing through a spare tire second stud plate terminal end; and
wherein the spare tire first stud hole is configured to receive a first spare tire stud of the spare tire carrier, the spare tire second stud hole is configured to receive a second spare tire stud of the spare tire carrier, a central tank mounting bracket flange hole is configured to receive a third spare tire stud of the spare tire carrier, the first tank mounting stud and the second tank mounting stud are configured to receive an air tank flange (230) extending from an air tank outer surface, the tank second mounting tab is located between 80° and 100° clockwise of the tank first mounting tab along the central tank mounting bracket flange outer perimeter, the spare tire first stud plate is located between 80° and 100° clockwise of the tank second mounting tab along the central tank mounting bracket flange outer perimeter, and the spare tire second stud plate is located between 80° and 100° clockwise of the spare tire first stud plate along the central tank mounting bracket flange outer perimeter.

4. The air compressor system of claim 1, wherein a second fluid conduit terminal end (321) of the second fluid conduit is configured to connect to an air tap (322), and wherein said air tap is connected to an air tap mount (330), said air tap mount comprising:
a central air tap mount plate (340) having a central air tap mount plate outer perimeter which is substantially circular, said central air tap mount plate comprising a plurality of central air tap mount plate stud holes (341) passing therethrough, a first peripheral slot (342), and a second peripheral slot (343) opposite the first peripheral slot;
a first air tap mount ear (350) attached to and extending from a central air tap mount plate perimeter first section (351) between the first peripheral slot and the second peripheral slot, said first air tap mount ear having a third peripheral slot (352); and
a second air tap mount ear (360) attached to and extending from a central air tap mount plate perimeter second section (361) opposite the central air tap mount plate perimeter first section, said second air tap mount ear having a fourth peripheral slot (362); and
wherein the air tap mount is configured to connect to the spare tire carrier by passing a plurality of spare tire studs through the plurality of central air tap mount plate stud holes, and the air tap is configured to selectively and slideably connect to the first peripheral slot, the second peripheral slot, the third peripheral slot, and/or the fourth peripheral slot.

5. The air compressor system of claim 1, further comprising a door compartment cover (600) having:
a door compartment cover main panel (610) having a main panel first edge (611), a main panel second edge (612) opposite the main panel first edge, a main panel first end (613), and a main panel second end (614) opposite the main panel first end, said main panel first edge, main panel second edge, main panel first end, and main panel second end forming a main panel plane defining a main panel upper surface (615) and a main panel lower surface (616) opposite the main panel upper surface; and
a door compartment cover lip (620) attached to and extending from the main panel first edge, said door compartment cover lip having a lip first edge (621), a lip second edge (622) opposite the lip first edge, a lip first end (623), and a lip second end (624) opposite the lip first end, said lip first edge, lip second edge, lip first end, and lip second end forming a lip plane defining a lip upper surface (625) and a lip lower surface (626) opposite the lip upper surface; and
wherein at least a compartment cover first mounting hole (617) passes from the main panel upper surface through the main panel lower surface adjacent to a first juncture between the main panel second edge and the main panel first end or adjacent to a second juncture between the main panel second edge and the main panel second end, and at least a compartment cover second mounting hole (627) passes from the lip upper surface through the lip lower surface adjacent to a third juncture between the lip first edge and the lip first end or adjacent to a fourth juncture between the lip first edge and the lip second end.

6. The air compressor system of claim 5, wherein a first bulkhead (311) is located within a first bulkhead aperture (312) passing from the main panel upper surface through the main panel lower surface, and the first fluid conduit includes a first fluid conduit first section (313) and a first fluid conduit second section (314) with the first fluid conduit first section connected between the air compressor outlet and the first bulkhead and the first fluid conduit second section connected between the first bulkhead and the air tank inlet.

7. The air compressor system of claim 5, wherein the door compartment cover main panel includes a plurality of door compartment cover vents (618) with each door compartment cover vent of the plurality of door compartment cover vents passing from the main panel upper surface through the main panel lower surface.

8. The air compressor system of claim 1, wherein the door compartment is located in a tailgate of a sport utility vehicle.

9. The air compressor system of claim 1, wherein at least a portion of the electrical communication connection is configured to extend through at least one rocker panel of the vehicle.

10. The air compressor system of claim 1, wherein the air tank includes an electrical pressure sensor in communication with the electric motor and configured to send a signal to turn off the electric motor when a predetermined amount of air pressure is detected in the air tank.

11. The air compressor system of claim 1, further comprising a switch (410) operably connected within the electrical communication connection between the vehicle battery and the electric motor.

12. A kit for mounting an air compressor assembly (100) within a door compartment (55) of a vehicle (50), said kit comprising:
the air compressor assembly having an electric motor (110) operably connected to a compressor (120), and air compressor inlet, and an air compressor outlet (140);
an air tank (200) having an air tank inlet (210) and an air tank outlet (220);
a first fluid conduit (310) configured to connect the air compressor outlet to the air tank inlet;
a second fluid conduit (320) configured to connect to and extend from the air tank outlet.
an electrical communication connection (400) configured to connect the electric motor to a vehicle battery (52);
a switch (410) configured to operably connect within the electrical communication connection between the vehicle battery and the electric motor;
an air compressor mounting bracket assembly (510) configured to connect the air compressor within the door compartment; and
at least one air tank mounting bracket (520) configured to connect the air tank to a spare tire carrier (53) which is attached to a door panel (51) of the vehicle.

13. The kit of claim 12, wherein the air compressor mounting bracket assembly comprises a first air compressor mounting bracket (530) having a first central plate (531), a compressor upper mounting plate (532) extending inwardly from a first central plate upper edge, a compressor first lower mounting tab (533) extending inwardly from a first central plate lower edge, a compressor second lower mounting tab (534) extending inwardly from the first central plate lower edge, and a door panel first mounting plate (535) extending outwardly from the first central plate lower edge; and wherein the compressor upper mounting plate is configured to connect to a compressor first upper mounting point (152) and a compressor second upper mounting point (153) by passing a first fastener through a first hole in the compressor upper mounting plate and into a first threaded hole in the compressor first upper mounting point and passing a second fastener through a second hole in the compressor upper mounting plate and into a second threaded hole in the compressor second upper mounting point, the compressor first lower mounting tab is configured to connect to a compressor first lower mounting point (151) by passing a third fastener through a third hole in the compressor first lower mounting tab and into a second threaded hole in the compressor first lower mounting point, and the door panel first mounting plate is configured to attach to a door compartment first mounting point (56) by passing each of a first plurality of door compartment fasteners through a corresponding first door compartment fastener hole and into a corresponding door panel first mounting plate threaded holes.

14. The kit of claim 12, wherein the air tank mounting bracket comprises:
a central tank mounting bracket flange (521) having an central tank mounting bracket flange outer perimeter;
a tank first mounting tab (522) extending from a first position on the central tank mounting bracket flange outer perimeter with a first tank mounting stud extending from a tank first mounting tab top surface;
a tank second mounting tab (524) extending from a second position on the central tank mounting bracket flange outer perimeter with a second tank mounting stud extending from a tank second mounting tab top surface;
a spare tire first stud plate (526) extending from a third position on the central tank mounting bracket flange outer perimeter with a spare tire first stud hole (527) passing through a spare tire first stud plate terminal end; and
a spare tire second stud plate (528) extending from a fourth position on the central tank mounting bracket flange outer perimeter with a spare tire second stud hole (529) passing through a spare tire second stud plate terminal end; and
wherein the spare tire first stud hole is configured to receive a first spare tire stud of the spare tire carrier, the spare tire second stud hole is configured to receive a second spare tire stud of the spare tire carrier, a central tank mounting bracket flange hole is configured to receive a third spare tire stud of the spare tire carrier, the first tank mounting stud and the second tank mounting stud are configured to receive an air tank flange (230) extending from an air tank outer surface, the tank second mounting tab is located between 80° and 100° clockwise of the tank first mounting tab along the central tank mounting bracket flange outer perimeter, the spare tire first stud plate is located between 80° and 100° clockwise of the tank second mounting tab along the central tank mounting bracket flange outer perimeter, and the spare tire second stud plate is located between 80° and 100° clockwise of the spare tire first stud plate along the central tank mounting bracket flange outer perimeter.

15. The kit of claim 12, further comprising:
an air tap (322);
an air tap mount (330) comprising:
a central air tap mount plate (340) having a central air tap mount plate outer perimeter which is substantially circular, said central air tap mount plate comprising a plurality of central air tap mount plate stud holes (341) passing therethrough, a first peripheral slot (342), and a second peripheral slot (343) opposite the first peripheral slot;
a first air tap mount ear (350) attached to and extending from a central air tap mount plate perimeter first section (351) between the first peripheral slot and the second peripheral slot, said first air tap mount ear having a third peripheral slot (352); and
a second air tap mount ear (360) attached to and extending from a central air tap mount plate perimeter second section (361) opposite the central air tap mount plate perimeter first section, said second air tap mount ear having a fourth peripheral slot (362); and
wherein a second fluid conduit terminal end (321) of the second fluid conduit is configured to connect to the air tap, the air tap is configured to connect to the air tap mount, the air tap mount is configured to connect to the spare tire carrier by passing a plurality of spare tire studs through the plurality of central air tap mount plate stud holes, and the air tap is configured to selectively and slideably connect to the first peripheral slot, the second peripheral slot, the third peripheral slot, and/or the fourth peripheral slot.

16. The kit of claim 12, further comprising a door compartment cover (600) having:
a door compartment cover main panel (610) having a main panel first edge (611), a main panel second edge (612) opposite the main panel first edge, a main panel first end (613), and a main panel second end (614) opposite the main panel first end, said main panel first edge, main panel second edge, main panel first end, and main panel second end forming a main panel plane defining a main panel upper surface (615) and a main panel lower surface (616) opposite the main panel upper surface; and
a door compartment cover lip (620) attached to and extending from the main panel first edge, said door compartment cover lip having a lip first edge (621), a lip second edge (622) opposite the lip first edge, a lip first end (623), and a lip second end (624) opposite the lip first end, said lip first edge, lip second edge, lip first end, and lip second end forming a lip plane defining a lip upper surface (625) and a lip lower surface (626) opposite the lip upper surface; and
wherein at least a compartment cover first mounting hole (617) passes from the main panel upper surface through the main panel lower surface adjacent to a first juncture between the main panel second edge and the main panel first end or adjacent to a second juncture between the main panel second edge and the main panel second end, and at least a compartment cover second mounting hole (627) passes from the lip upper surface through the lip lower surface adjacent to a third juncture between the lip first edge and the lip first end or adjacent to a fourth juncture between the lip first edge and the lip second end.

17. The kit of claim 15, further comprising a first bulkhead (311) configured to attach to a first bulkhead aperture (312) passing from the main panel upper surface through the main panel lower surface, and the first fluid conduit includes a first fluid conduit first section (313) and a first fluid conduit second section (314) with the first fluid conduit first section configured to connect between the air compressor outlet and the first bulkhead and the first fluid conduit second section configured to connect between the first bulkhead and the air tank inlet.

18. The kit of claim 15, wherein the door compartment cover main panel includes a plurality of door compartment cover vents (618) with each door compartment cover vent of the plurality of door compartment cover vents passing from the main panel upper surface through the main panel lower surface.

19. The kit of claim 12, wherein at least a portion of the electrical communication connection is configured to extend through at least one rocker panel of the vehicle.

20. The kit of claim 12, further comprising a switch (410) configured to operably connect within the electrical communication connection between the vehicle battery and the electric motor.
